(19) United States
(12) Patent Application Publication
(10) Pub. No.: US 2026/0296291 A1
(43) Pub. Date: Oct. 1, 2026

(54) SEAT

(71) Applicants: NHK SPRING CO., LTD., Yokohama-shi (JP); TOYOTA JIDOSHA KABUSHIKI KAISHA, Toyota-shi (JP)

(72) Inventors: Kenzo YASUDA, Yokohama-shi (JP); Daisuke TANAKA, Yokohama-shi (JP); Kouichi YAMADA, Yokohama-shi (JP); Kousuke YONEMOCHI, Yokohama-shi (JP); Akira KANEKO, Toyota-shi (JP); Risa NAKAJIMA, Toyota-shi (JP)

(21) Appl. No.: 19/578,180

(22) Filed: Mar. 25, 2026

(30) Foreign Application Priority Data
Mar. 26, 2025 (JP) 2025-052594

(51) Int. Cl. B60N 3/06

(52) U.S. Cl. CPC B60N 3/063

(57) ABSTRACT

A seat, includes: a seat cushion at which a vehicle occupant may be seated; an extension including a footrest cushion and a pair of stays, the footrest cushion extending along a seat width direction, and the pair of stays respectively arranged at respective sides, in the seat width direction, of the footrest cushion and extending from the footrest cushion toward a seat rear side; and a pair of holders configured to retain the pair of stays with respect to the seat cushion. The extension is configured to adopt a first mode and a second mode and, when viewed from an extension direction of a seat face of the seat cushion as viewed in the seat width direction, the footrest cushion overlaps with the seat cushion in the first mode, and the footrest cushion does not overlap with the seat cushion in the second mode.

### CROSS-REFERENCE TO RELATED APPLICATION

This application claims priority under 35 USC 119 from Japanese Patent Application No. 2025-052594 filed Mar. 26, 2025, the disclosure of which is incorporated by reference herein in its entirety.

### BACKGROUND

### Technical Field

The present disclosure relates to a seat.

### Related Art

Japanese Patent Application Laid-Open (JP-A) No. 2025-023062 discloses an invention related to a vehicle seat device.

In this vehicle seat device, a footrest is provided at a back face side of a front row seat, enabling feet of a passenger seated in a rear row seat to be supported by the footrest.

### SUMMARY

However, in the related art described in JP-A No. 2025-023062, a separate seat is needed for placement of the footrest, with the configuration being complicated.

Namely, in the related art described in JP-A No. 2025-023062, there is room for improvement from the perspective of enabling a passenger to be seated in a comfortable posture, while suppressing the seat configuration from becoming complicated.

In consideration of the above circumstances, the present disclosure is to obtain a seat that enables a passenger to be seated in a comfortable posture, while suppressing the seat configuration from becoming complicated.

A seat according to a first aspect includes a seat cushion at which a vehicle occupant may be seated, an extension including a footrest cushion and a pair of stays, the footrest cushion extending along a seat width direction, and the pair of stays respectively arranged at respective sides in a seat width direction, of the footrest cushion and extending from the footrest cushion toward a seat rear side, and a pair of holders configured to retain the pair of stays with respect to the seat cushion. The extension is configured to adopt a first mode and a second mode, when viewed from an extension direction of a seat face of the seat cushion as viewed in the seat width direction, the footrest cushion overlaps with the seat cushion in the first mode, and the footrest cushion does not overlap with the seat cushion in the second mode.

The seat according to the first aspect includes the seat cushion and enables a vehicle occupant to sit on the seat cushion.

A seat front-rear direction length of the seat cushion that is appropriate for seating a vehicle occupant is different when the vehicle occupant is of large build or of small build, and preferably the seat front-rear direction length of the seat cushion is able to accommodate the build of the vehicle occupant when the vehicle occupant sits in a comfortable posture on the seat cushion. Moreover, from the perspective of enabling a vehicle occupant to be seated in a comfortable posture on the seat cushion, the feet of the vehicle occupant in a seated state on the seat cushion can preferably be supported.

Thus the present aspect includes the extension having the footrest cushion extending in the seat width direction and the pair of stays respectively arranged at each side, in the seat width direction, of the footrest cushion and extending from the footrest cushion toward the seat rear side.

The extension can be placed at a specific position by the stays being retained by the holders with respect to the seat cushion. Specifically, as viewed in the seat width direction, the extension is able to adopt a first mode in which the footrest cushion overlaps with the seat cushion when viewed from an extension direction of a seat face of the seat cushion and a second mode in which the footrest cushion does not overlap with the seat cushion.

This means that in cases in which the build of a vehicle occupant is large, the seating face for the vehicle occupant to sit on can be extended toward the seat front side using the footrest cushion by the extension adopting the first mode. Moreover, in cases in which the build of a vehicle occupant is small, the seating face for the vehicle occupant to sit on can be contracted by moving the footrest cushion to the lower side of the seat cushion by the extension adopting the second mode. Furthermore, by moving the footrest cushion toward the seat front side when in the second mode, the feet of a vehicle occupant in a seated state on the seat cushion can be supported by the footrest cushion without needing to provide a separate footrest.

A seat according to a second aspect is the seat according to the first aspect, in which plural first notches are provided at one of the pair of the stays positioned at one side in the seat width direction, when the extension is in the first mode, the first notches are spaced apart along an extension direction of the one stay, plural second notches are provided at the other stay of the pair of the stays positioned at the one side in the seat width direction when the extension is in the second mode, the second notches are spaced apart along an extension direction of the other stay, a lock portion configured engageably with the first notches and the second notches is provided only at the holder on the one side in the seat width direction, and at least one of the second notches is arranged at a position engageable with the lock portion in a state in which the footrest cushion in the second mode is positioned further toward a seat rear side than a front end of the seat cushion.

In the seat according to the second aspect, the plural first notches are provided at the one stay positioned at the one side in the seat width direction when the extension is in the first mode, and the first notches are spaced apart along the extension direction of the one stay.

Moreover, the plural second notches are provided at the other stay positioned at the one side in the seat width direction when the extension is in the second mode, and the second notches are also spaced apart along the extension direction of the other stay.

Moreover, the lock portion configured engageably with the first notches and the second notches is provided only at the holder on the one side in the seat width direction.

This means that in the present aspect, the position of the extension can be fixed in either state of the first mode or the second mode of the extension.

Moreover, in the present aspect at least one of the second notches is arranged at the position engageable with the lock portion in the state in which the footrest cushion in the second mode is positioned further toward the seat rear side than the front end of the seat cushion. This thereby enables the extension to be fixed in the second mode at a position where the footrest cushion is not liable to hit the legs of the passenger.

As described above, the seat according to the present disclosure exhibits the advantageous effect of enabling a passenger to be seated in a comfortable posture while suppressing the configuration of a seat from becoming complicated.

### BRIEF DESCRIPTION OF THE DRAWINGS

Exemplary embodiments of the present disclosure will be described in detail based on the following figures, wherein:

FIG. 1 is a perspective view schematically illustrating a configuration of a vehicle seat according to an exemplary embodiment;

FIG. 2 is a perspective view schematically illustrating a configuration of an extension configuring part of a vehicle seat according to the present exemplary embodiment;

FIG. 3 is a plan view schematically illustrating a configuration of an extension configuring part of a vehicle seat according to the present exemplary embodiment;

FIG. 4 is a side view (viewed along the direction of arrow 4 in FIG. 2) schematically illustrating a configuration of a stay of an extension configuring part of a vehicle seat according to the present exemplary embodiment;

FIG. 5 is a side view (viewed along the direction of arrow 5 in FIG. 2) schematically illustrating a configuration of a stay of an extension configuring part of a vehicle seat according to the present exemplary embodiment;

FIG. 6 is a side view schematically illustrating a state in which an extension of a vehicle seat according to the present exemplary embodiment is in a first mode; and

FIG. 7 is a side view schematically illustrating a state in which an extension of a vehicle seat according to the present exemplary embodiment is in a second mode.

### DETAILED DESCRIPTION

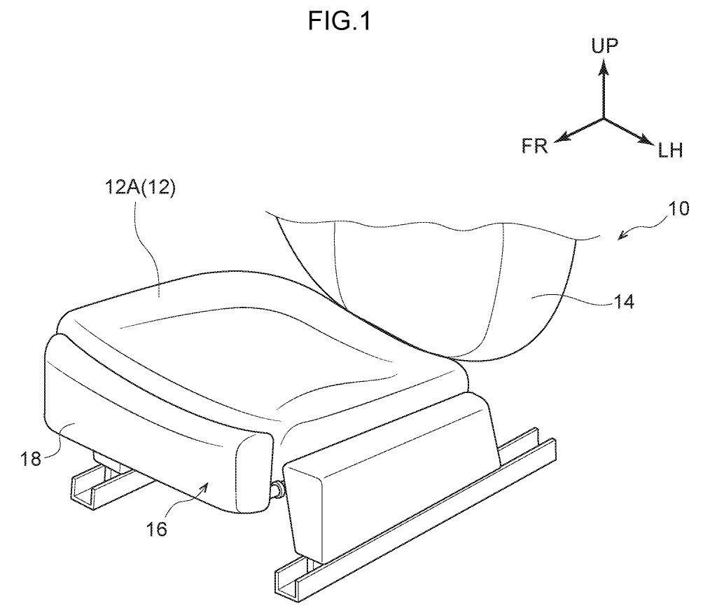

Description follows regarding examples of exemplary embodiments of a seat according to the present disclosure, with reference to FIGS. 1 to 7. As illustrated in FIG. 1, a vehicle seat 10 serving as a seat according to the present exemplary embodiment (hereinafter called seat 10) includes a seat cushion 12 a passenger is able to sit on, a seatback 14 for supporting the back of the passenger, and an extension 16.

The seat 10 is arranged with the front side thereof at the vehicle front side. Note that, as appropriate in the drawings, arrow FR indicates the front side of the seat 10, arrow UP indicates upward for the seat 10, and arrow LH indicates the left side of the seat 10. Moreover in the following, unless explicitly stated otherwise, the seat front-rear direction means the front-rear direction of the seat 10, the seat height direction means the height direction of the seat 10, and the seat width direction means the width direction of the seat 10.

Moreover, although the extension 16 is able to adopt a first mode and a second mode, as described below, unless explicitly stated otherwise, the assumption is that the extension 16 continues to be in the first mode.

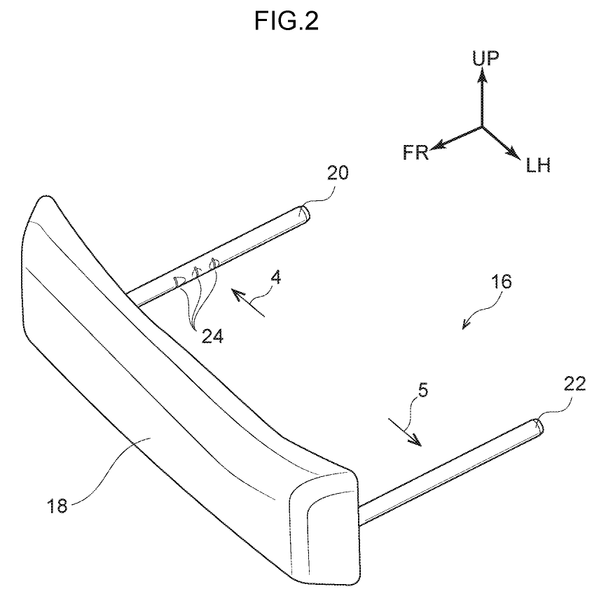

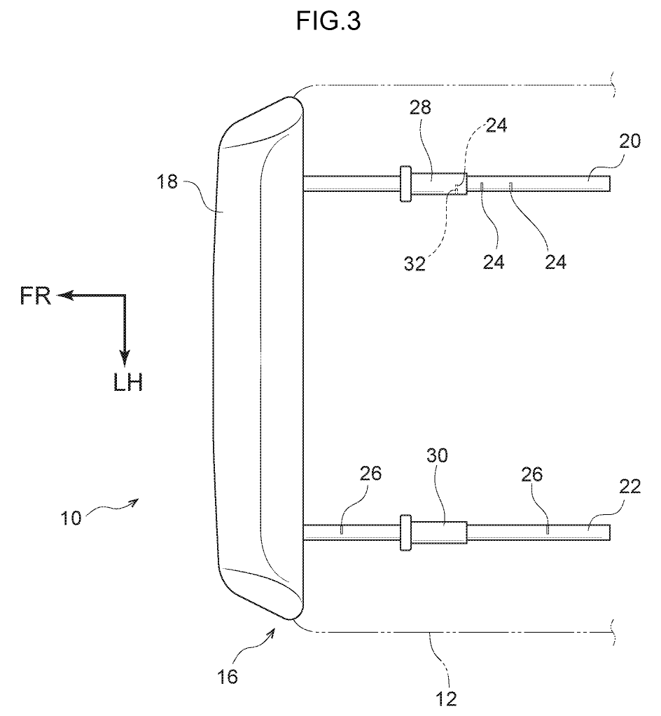

As illustrated in FIGS. 2 and 3, the extension 16 includes a footrest cushion 18, a first stay 20 serving as a stay, and a second stay 22 serving as a stay.

More specifically, the footrest cushion 18 includes a non-illustrated cushion member, and a covering 18A encapsulating the cushion member, and is configured in a cuboidal shape extending in the seat width direction. At a seat lower side portion of a back face of the footrest cushion 18, the first stay 20 is arranged at a seat right side and the second stay 22 is arranged at a seat left side.

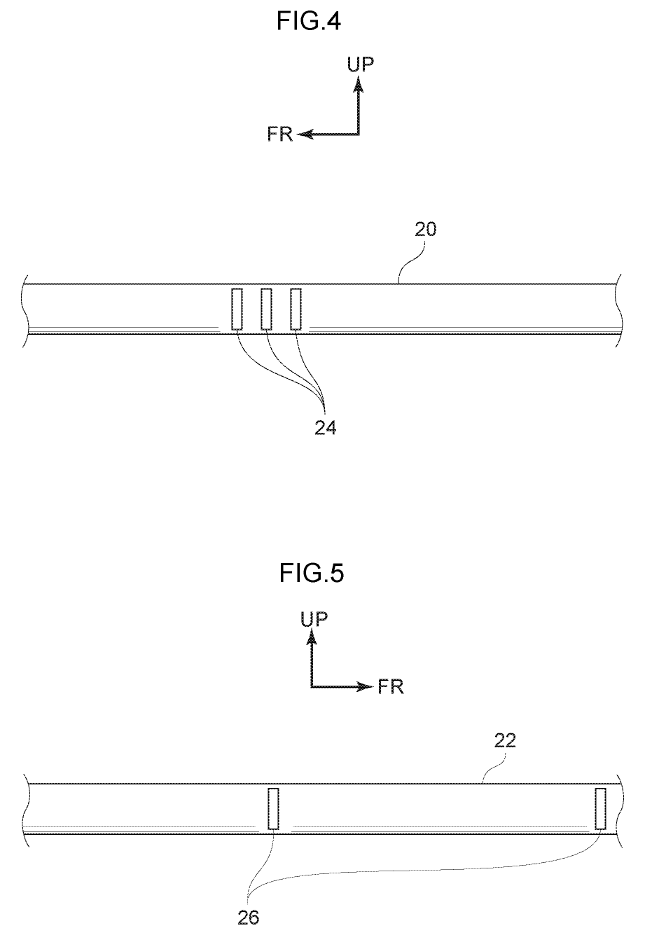

The first stay 20 is configured from a pipe material and extends toward the seat rear side from the footrest cushion 18. Moreover, as illustrated in FIG. 4, plural (for example 3) first notches 24 are formed at a seat width direction inner side portion of the first stay 20, at a fixed spacing along the extension direction of the first stay 20.

The second stay 22 is configured from a pipe material and extends from the footrest cushion 18 toward the seat rear side. Moreover, as illustrated in FIG. 5, plural (for example 2) second notches 26 are formed at a seat width direction inner side portion of the second stay 22 at a fixed spacing along the extension direction of the second stay 22. Note that the spacing between the second notches 26 is wider than the spacing between the first notches 24. The first stay 20 and the second stay 22 are configured so as to be retained by a first holder 28 serving as a holder and a second holder 30 serving as a holder.

The first holder 28 is attached to a seat width direction right side portion of a non-illustrated seat cushion frame supporting the seat cushion 12 by a non-illustrated attachment bracket. The first holder 28 allows the first stay 20 and the second stay 22 to be inserted therein along their extension directions, and includes a lock portion 32 that is engageable with the first notches 24 and the second notches 26. Namely, the first holder 28 is able to restrict relative movement of the extension 16 with respect to the seat cushion 12 by the first notches 24 or the second notches 26 engaging with the lock portion 32.

The second holder 30 is attached to a seat width direction left side portion of the seat cushion frame through a non-illustrated attachment bracket. The second holder 30 allows the first stay 20 and the second stay 22 to be inserted therein along their extension directions. Note that the second holder 30 does not include a lock portion engageable with the first notches 24 and the second notches 26.

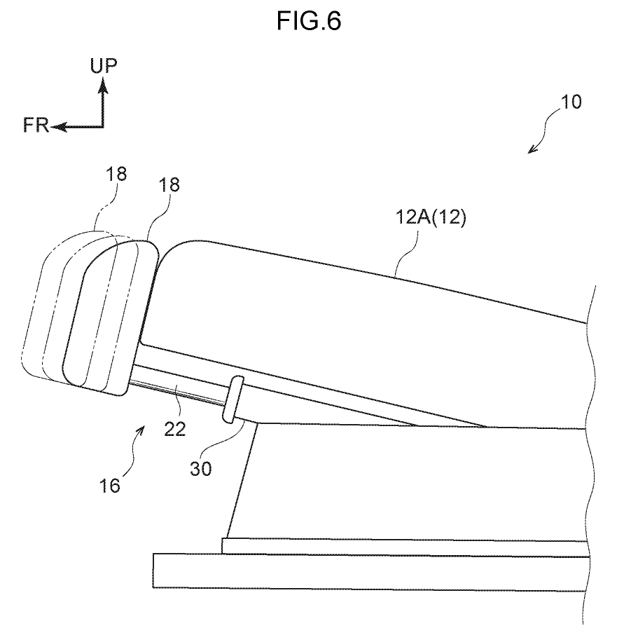

The present exemplary embodiment is configured such that the first mode illustrated in FIG. 6 is adopted when the extension 16 is arranged such that the first stay 20 is retained by the first holder 28 and the second stay 22 is retained by the second holder 30.

In the first mode, as viewed in the seat width direction, the footrest cushion 18 overlaps with the seat cushion 12 when viewed from an extension direction of a seating face 12A of the seat cushion 12. Moreover, configuration is such that, in the first mode, the footrest cushion 18 and the seat cushion 12 are adjacent to each other when the first notch 24 furthest to the seat front side engages with the lock portion 32.

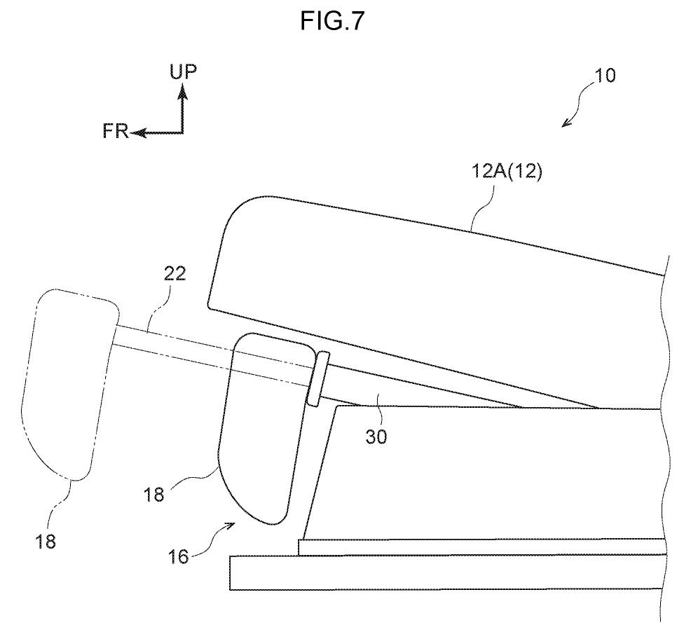

Moreover, the present exemplary embodiment is configured such that the second mode illustrated in FIG. 7 is adopted when the extension 16 is arranged such that the second stay 22 is retained in the first holder 28 and the first stay 20 is retained in the second holder 30.

In this second mode, as viewed in the seat width direction, the footrest cushion 18 does not overlap with the seat cushion 12 when viewed from an extension direction of the seating face 12A of the seat cushion 12. Moreover, in the second mode, when the second notch 26 at the seat front side engages with the lock portion 32, the footrest cushion 18 is hidden by the seat cushion 12 when viewed along the seat height direction. In other words, the second notch 26 at the seat front side is arranged at a position engageable with the lock portion 32 in a state in which the footrest cushion 18 in the second mode is positioned further toward the seat rear side than the front end of the seat cushion 12.

However, when the second notch 26 at the seat rear side engages with the lock portion 32, the footrest cushion 18 is configured so as to be positioned at the seat front side of the seat cushion 12.

### Operation and Advantageous Effects of Present Exemplary Embodiment

Description follows regarding the operation and advantageous effects of the present exemplary embodiment.

In the present exemplary embodiment, as illustrated in FIG. 1, the seat cushion 12 is provided, enabling a passenger to sit on the seat cushion 12.

However, the appropriate seat front-rear direction length of the seat cushion 12 for seating of a passenger is different when the passenger sitting on the seat cushion 12 is of large build or of small build, and preferably the length in the seat front-rear direction of the seat cushion 12 is able to accommodate the build of the passenger when the passenger sits in a comfortable posture on the seat cushion 12. Moreover, from the perspective of the passenger sitting in a comfortable posture on the seat cushion 12, preferably the legs of the passenger can be supported in a state seated on the seat cushion 12.

The present exemplary embodiment, as illustrated in FIGS. 2 and 3, includes the footrest cushion 18 extending in the seat width direction, and the extension 16 equipped with the first stay 20 and the second stay 22 that are respectively arranged at each seat width direction side of the footrest cushion 18 and that extend toward the seat rear side from the footrest cushion 18.

The extension 16 can be placed in a specific position by the first stay 20 and the second stay 22 being retained by the first holder 28 and the second holder 30 with respect to the seat cushion 12. Specifically, as illustrated in FIG. 6 and FIG. 7, the extension 16 is able to adopt the first mode in which, when viewed from the seat width direction, the footrest cushion 18 overlaps with the seat cushion 12 when viewed from the extension direction of the seating face 12A of the seat cushion 12, and the second mode in which the footrest cushion 18 does not overlap with the seat cushion 12.

This means that in cases in which the build of the passenger is large, the footrest cushion 18 can be employed to achieve an extension length to the seat front side of the seating face by the extension 16 adopting the first mode. Moreover, in cases in which the build of the passenger is small, the footrest cushion 18 can be moved to the lower side of the seat cushion 12 so as to achieve a contraction in the seating face by the extension 16 adopting the second mode. Furthermore, moving the footrest cushion 18 to the seat front side in the second mode obviates a need to provide a separate footrest, enabling the feet of the passenger seated on the seat cushion 12 to be supported by the footrest cushion 18.

Moreover, in the present exemplary embodiment, as illustrated in FIGS. 4 and 5, plural of the first notches 24 spaced apart in the extension direction of the first stay 20 are provided at the first stay 20 that is positioned at the seat width direction one side when the extension 16 is in the first mode.

Moreover, the second notches 26 provided at the second stay 22 that is positioned at the seat width direction one side when the extension 16 is in the second mode are spaced wider in the extension direction of the second stay 22 than the spacing between the first notches 24.

Moreover, the lock portion 32 engageable with the first notches 24 and the second notches 26 is only provided at the first holder 28.

This means that in the present exemplary embodiment, the position of the extension 16 can be fixed when the extension 16 is in a state both in the first mode and on the second mode, and the position of the extension 16 can be set independently when the extension 16 is in the first mode and when the extension 16 is in the second mode. Moreover, fine adjustments to the position of the footrest cushion 18 is more easily performed in the first mode of the extension 16 than in the second mode of the extension 16.

Moreover, in the present exemplary embodiment, at least one of the second notches 26 is arranged at a position engageable by the lock portion 32 in a state in which the footrest cushion 18 in the second mode is positioned further toward the seat rear side than the front end of the seat cushion 12. This means that in the second mode the extension 16 can be fixed at a position where the footrest cushion 18 is not liable to hit the legs of the passenger.

As described above, the present exemplary embodiment enables a passenger to be seated in a comfortable posture while suppressing the configuration of the seat 10 from becoming complicated.

Note that although in the above exemplary embodiment explanation has been given to a case in which the present disclosure is applied to a vehicle seat, the present disclosure is applicable to a seat used in transportation other than a vehicle (for example in an aircraft or boat).

What is claimed is:

1. A seat, comprising:
a seat cushion at which a vehicle occupant may be seated;
an extension including a footrest cushion and a pair of stays, the footrest cushion extending along a seat width direction, and the pair of stays respectively arranged at respective sides, in the seat width direction, of the footrest cushion and extending from the footrest cushion toward a seat rear side; and
a pair of holders configured to retain the pair of stays with respect to the seat cushion,
wherein the extension is configured to adopt a first mode and a second mode and, when viewed from an extension direction of a seat face of the seat cushion as viewed in the seat width direction, the footrest cushion overlaps with the seat cushion in the first mode, and the footrest cushion does not overlap with the seat cushion in the second mode.

2. The seat of claim 1, wherein:
a plurality of first notches are provided at one of the pair of stays positioned at one side in the seat width direction when the extension is in the first mode, the first notches being spaced apart along an extension direction of the one stay;
a plurality of second notches provided at the other of the pair of stays positioned at the one side in the seat width direction when the extension is in the second mode, the second notches being spaced apart along an extension direction of the other stay;
a lock portion configured engageably with the first notches and the second notches is provided only at the holder on the one side in the seat width direction; and
at least one of the second notches is arranged at a position engageable with the lock portion in a state in which the footrest cushion in the second mode is positioned further toward a seat rear side than a front end of the seat cushion.
